(19) United States
(12) Patent Application Publication
(10) Pub. No.: US 2026/0234386 A1
(43) Pub. Date: Aug. 13, 2026

(54) THERMOPLASTIC ELASTOMER COMPOSITION, METHOD FOR PRODUCING THE SAME, AND USE THEREOF

(71) Applicant: SUMITOMO CHEMICAL COMPANY, LIMITED, Tokyo (JP)

(72) Inventor: Katsuya KIDA, Chiba (JP)

(21) Appl. No.: 19/633,465

(22) Filed: Mar. 30, 2026

(30) Foreign Application Priority Data
May 23, 2023 (JP) 2025-086286

(51) Int. Cl. C08L 23/16; B60R 13/02

(52) U.S. Cl. CPC C08L 23/16; B60R 13/02; C08L 2205/025; C08L 2205/035; C08L 2207/04; C08L 2207/062; C08L 2207/322; C08L 2312/00

(57) ABSTRACT

Provided is a thermoplastic elastomer composition capable of forming a molded article having low high-speed puncture impact energy and excellent split-open performance. A thermoplastic elastomer composition contains 100 parts by mass of (A) an ethylene-α-olefin copolymer and 20 parts by mass to 90 parts by mass of (B) a propylene-based polymer, in which a ratio of structural units derived from ethylene in all structural units of the ethylene-α-olefin copolymer (A) is 55 mass % or more and less than 80 mass %, and a product r1r2 of monomer reactivity ratios of the ethylene-α-olefin copolymer (A) is 1.8 or less.

### BACKGROUND OF THE INVENTION

### Field of the Invention

The present invention relates to a thermoplastic elastomer composition.

### Description of the Related Art

Thermoplastic elastomers are used in various applications, including vehicle parts, for example, automobile parts, and are used for automobile interior materials, for example, a skin material for a cover (instrument panel) of an airbag device (see, for example, WO 2021/200928 A1).

On the back side of the skin material, tear-line processing (forming a cut for deploying an airbag) is usually performed to assist deployment of the airbag; however, in order to reduce production man-hours and achieve rationalization, there is a demand for a skin material having excellent split-open performance that can be easily split open even without tear-line processing.

### SUMMARY OF THE INVENTION

An object of the present invention is to provide a thermoplastic elastomer composition capable of forming a molded article having low high-speed puncture impact energy and excellent split-open performance.

The present inventors have conducted intensive studies in view of such a background, and completed the present invention.

That is, the present invention relates to:

[1]

A thermoplastic elastomer composition containing 100 parts by mass of (A) an ethylene-α-olefin copolymer and 20 parts by mass to 90 parts by mass of (B) a propylene-based polymer,
in which a ratio of structural units derived from ethylene in all structural units of the ethylene-α-olefin copolymer (A) is 55 mass % or more and less than 80 mass %, and
a product r1r2 of monomer reactivity ratios of the ethylene-α-olefin copolymer (A) is 1.8 or less.

Hereinafter, [2] to are preferred aspects or embodiments of the present invention.

[2]

The thermoplastic elastomer composition according to [1], in which a molar fraction AA of α-olefin-α-olefin sequences in the ethylene-α-olefin copolymer (A) is 8.5 molo or less (provided that a total of peak areas AA, AE, and EE is defined as 100 mol %, where the peak area AA is derived from a portion in which monomer units are bonded in the order of an α-olefin unit and an α-olefin unit, the peak area AE is derived from a portion in which monomer units are bonded in the order of an α-olefin unit and an ethylene unit, and the peak area EE is derived from a portion in which monomer units are bonded in the order of an ethylene unit and an ethylene unit).

[3]

The thermoplastic elastomer composition according to [1] or [2], in which the ethylene-α-olefin copolymer (A) has a structural unit derived from a non-conjugated diene.

[4]

The thermoplastic elastomer composition according to any one of [1] to [3], further containing (C) mineral oil.

[5]

The thermoplastic elastomer composition according to any one of [1] to [4], further containing (D) a crosslinking agent.

[6]

The thermoplastic elastomer composition according to any one of [1] to [5], further containing (E) an inorganic filler.

[7]

The thermoplastic elastomer composition according to any one of [1] to [6], further containing (F) an ethylene-based resin in which a ratio of structural units derived from ethylene is 80 mass % or more.

[8]

The thermoplastic elastomer composition according to [7], in which a density of the ethylene-based resin (F) is 950 kg/m³ or more.

[9]

A method for producing the thermoplastic elastomer composition according to any one of [1] to [8], the method including melt-kneading (A) an ethylene-α-olefin copolymer and (B) a propylene-based polymer in the presence of (D) a crosslinking agent.

[10]

The method for producing the thermoplastic elastomer composition according to [9], the method further including adding (F) an ethylene-based resin to a melt-kneaded product obtained by melt-kneading the ethylene-α-olefin copolymer (A) and the propylene-based polymer (B) in the presence of the crosslinking agent (D), and further melt-kneading the resulting mixture.

[11]

A molded article containing the thermoplastic elastomer composition according to any one of [1] to [8],
in which a compression set is 36% to 70% as measured in accordance with JIS K6262 at a compression ratio of 25%, a test temperature of 70° C., and a test time of 22 hours.
   [12]

A vehicle interior skin containing the thermoplastic elastomer composition according to any one of [1] to [8].

According to the present invention, it is possible to provide a thermoplastic elastomer composition capable of forming a molded article having low high-speed puncture impact energy and excellent split-open performance.

### BRIEF DESCRIPTION OF THE DRAWINGS

FIG. 1 is a ¹³C-NMR spectrum of an ethylene-α-olefin copolymer used in an embodiment of the present invention.

### DETAILED DESCRIPTION OF THE PREFERRED EMBODIMENTS

The present invention provides:
a thermoplastic elastomer composition containing 100 parts by mass of (A) an ethylene-α-olefin copolymer and 20 parts by mass to 90 parts by mass of (B) a propylene-based polymer,
in which a ratio of structural units derived from ethylene in all structural units of the ethylene-α-olefin copolymer (A) is 55 mass % or more and less than 80 mass %, and
a product r1r2 of monomer reactivity ratios of the ethylene-α-olefin copolymer (A) is 1.8 or less.

That is, the thermoplastic elastomer composition of the present invention contains the component (A) and the component (B), and the component (A) has a specified monomer composition and a specified product of monomer reactivity ratios.

The thermoplastic elastomer composition of the present invention can provide moldability derived from thermoplasticity and rubber elasticity after molding by containing the component (A) and the component (B).

The thermoplastic elastomer composition of the present invention may be composed only of the component (A) and the component (B), which are essential components, and may contain, in addition to the component (A) and the component (B), other optional components, such as (C) mineral oil, (D) a crosslinking agent, (E) an inorganic filler, and/or (F) an ethylene-based resin, which will be described below.

Hereinafter, the essential components and the optional components will be described.

### (A) Ethylene-α-Olefin Copolymer

The ethylene-α-olefin copolymer (A) constituting the thermoplastic elastomer composition of the present invention is a copolymer having structural units derived from ethylene and structural units derived from at least one monomer selected from the group consisting of α-olefins having 3 to 10 carbon atoms.

A ratio of structural units derived from ethylene in all structural units of the ethylene-α-olefin copolymer (A) is 55 mass % or more and less than 80 mass.

Since the ratio of structural units derived from ethylene is 55 mass % or more, the ethylene-α-olefin copolymer (A) is a crosslinkable polymer, and is suitable for constituting an island phase of a sea-island structure of the thermoplastic elastomer composition by dynamic crosslinking.

Since the ratio of structural units derived from ethylene is less than 80 mass %, flexibility and rubber elasticity are excellent.

The ethylene-α-olefin copolymer (A) is preferably a random copolymer.

The ethylene-α-olefin copolymer (A) may be composed only of structural units derived from ethylene and structural units derived from at least one monomer selected from the group consisting of α-olefins having 3 to 10 carbon atoms, and may have other structural units.

Examples of the α-olefins having 3 to 10 carbon atoms include propylene, 1-butene, 2-methylpropene, 1-pentene, 3-methyl-1-butene, 1-hexene, 3-methyl-1-pentene, 4-methyl-1-pentene, 1-heptene, 1-octene, 1-nonene, 1-decene, and cyclic olefins such as vinylcyclohexane. In the preparation of the ethylene-α-olefin copolymer (A), the α-olefin having 3 to 10 carbon atoms may be used alone or two or more thereof may be used. Preferred examples of the structural units derived from at least one selected from the group consisting of α-olefins having 3 to 10 carbon atoms include a structural unit derived from propylene, a structural unit derived from 1-butene, a structural unit derived from 4-methyl-1-pentene, a structural unit derived from 1-hexene, or a structural unit derived from 1-octene.

In the ethylene-α-olefin copolymer (A), a ratio of structural units derived from ethylene is 55 mass % or more and less than 80 mass %, preferably 58 mass % or more and 78 mass % or less, more preferably 60 mass % or more and 75 mass % or less, and particularly preferably 62 mass % or more and 73 mass % or less (provided that the amount of all structural units of the ethylene-α-olefin copolymer (A) is 100 mass %). In the ethylene-α-olefin copolymer (A), a ratio of structural units derived from at least one selected from the group consisting of α-olefins having 3 to 10 carbon atoms is 10 mass % or more, preferably 15 mass or more and 45 mass % or less, more preferably 20 mass % or more and 37 mass % or less, and particularly preferably 24 mass or more and 33 mass % or less (provided that the amount of all structural units of the ethylene-α-olefin copolymer (A) is 100 mass %).

Since the ratio of structural units derived from ethylene in the ethylene-α-olefin copolymer (A) is 55 mass % or more, together with the other requirements of the present invention, the thermoplastic elastomer composition of the present invention can achieve a technical effect of being capable of forming a molded article having low high-speed puncture impact energy and excellent split-open performance, and a technical effect of improving mechanical properties and flexibility.

The ratio of structural units derived from ethylene in the ethylene-α-olefin copolymer (A) and the ratio of structural units derived from at least one monomer selected from the group consisting of α-olefins having 3 to 10 carbon atoms can be determined by infrared spectroscopy. Specifically, an infrared absorption spectrum of the ethylene-α-olefin copolymer (A) is measured using an infrared spectrophotometer, and the ratio of structural units derived from ethylene and the ratio of structural units derived from at least one monomer selected from the group consisting of α-olefins having 3 to 10 carbon atoms can be calculated in accordance with the method described in “Characterization of Polyethylene by Infrared Absorption Spectrum” (Takayama, Usami et al.) or “Die Makromolekulare Chemie, 177, 461 (1976) (McRae, M. A., Madams, W. F. et al.)”. The ratio of structural units derived from ethylene and the ratio of structural units derived from at least one monomer selected from the group consisting of α-olefins having 3 to 10 carbon atoms in components (A-1) and (A-2) described below can also be determined in the same manner.

The ethylene-α-olefin copolymer (A) may have structural units derived from monomers other than ethylene and at least one selected from the group consisting of α-olefins having 3 to 10 carbon atoms. Examples of the other monomers include chain non-conjugated dienes, such as 1,4-hexadiene, 1,6-octadiene, 2-methyl-1,5-hexadiene, 6-methyl-1,5-heptadiene, and 7-methyl-1,6-octadiene; cyclic non-conjugated dienes, such as 1,5-dicyclooctadiene, cyclohexadiene, cyclopentadiene, dicyclopentadiene, methyltetrahydroindene, 5-vinyl-2-norbornene, 5-ethylidene-2-norbornene, 5-methylene-2-norbornene, 5-isopropylidene-2-norbornene, and 6-chloromethyl-5-isopropenyl-2-norbornene; trienes, such as 2,3-diisopropylidene-5-norbornene, 2-ethylidene-3-isopropylidene-5-norbornene, 2-propenyl-2,2-norbornadiene, and 4-ethylidene-8-methyl-1,7-nonadiene; vinyl carboxylates, such as vinyl acetate; unsaturated carboxylic acid esters, such as methyl acrylate, ethyl acrylate, butyl acrylate, methyl methacrylate, and ethyl methacrylate; and unsaturated carboxylic acids, such as acrylic acid and methacrylic acid. The ethylene-α-olefin copolymer (A) may have structural units derived from two or more kinds of such other monomers. From the viewpoint of crosslinkability, such other monomers are preferably non-conjugated dienes having 5 to 15 carbon atoms, and more preferably 5-ethylidene-2-norbornene, dicyclopentadiene, 5-vinyl-2-norbornene, or a combination thereof.

When the ethylene-α-olefin copolymer (A) has structural units derived from monomers other than ethylene and at least one selected from the group consisting of α-olefins having 3 to 10 carbon atoms, a ratio of structural units derived from such other monomers is preferably 2 mass % or more and 15 mass % or less, and more preferably 3 mass % or more and 8 mass % or less (provided that a total amount of the ethylene-α-olefin copolymer (A) is 100 mass %). The ratio of structural units derived from such other monomers can be determined by the above-described infrared spectroscopy. The ratio of structural units derived from such other monomers in components (A-1) and (A-2) described below can also be determined in the same manner.

Examples of the ethylene-α-olefin copolymer (A) include an ethylene-propylene copolymer, an ethylene-1-butene copolymer, an ethylene-1-hexene copolymer, an ethylene-4-methyl-1-pentene copolymer, an ethylene-1-octene copolymer, an ethylene-propylene-1-butene copolymer, an ethylene-propylene-1-hexene copolymer, and an ethylene-propylene-1-octene copolymer. From the viewpoint of crosslinkability, the ethylene-α-olefin copolymer (A) is preferably an ethylene-α-olefin-non-conjugated diene copolymer. Examples thereof include an ethylene-propylene-5-ethylidene-2-norbornene copolymer, an ethylene-propylene-dicyclopentadiene copolymer, an ethylene-propylene-1,4-hexadiene copolymer, an ethylene-propylene-5-vinyl-2-norbornene copolymer, an ethylene-1-butene-5-ethylidene-2-norbornene copolymer, an ethylene-1-butene-dicyclopentadiene copolymer, an ethylene-1-butene-1,4-hexadiene copolymer, and an ethylene-1-butene-5-vinyl-2-norbornene copolymer. The ethylene-α-olefin copolymer (A) may also be an olefin-based block copolymer containing a polymer block composed of ethylene and an ethylene-α-olefin copolymer block. The ethylene-based copolymer as the component (A) may be used alone or two or more thereof may be used. As the component (A), an ethylene-propylene-5-ethylidene-2-norbornene copolymer can be preferably used. In the present embodiment, the ethylene-α-olefin copolymer is preferably an ethylene-α-olefin copolymer having a JIS K6253 A hardness of 85 or less.

The product r1r2 of monomer reactivity ratios of the ethylene-α-olefin copolymer (A), which is a component of the thermoplastic elastomer composition of the present invention, is 1.8 or less.

By using the ethylene-α-olefin copolymer (A) in which the product r1r2 of monomer reactivity ratios is 1.8 or less, together with the other technical features of the present invention, the thermoplastic elastomer composition of the present invention can achieve a remarkable technical effect of overcoming limitations of conventional techniques by being capable of forming a molded article having low high-speed puncture impact energy and excellent split-open performance.

The product r1r2 of monomer reactivity ratios can be determined from peak areas AA, AE, and EE in a ¹³C-NMR spectrum of an ethylene-α-olefin copolymer and the following Formula (2) under the conditions described below.

$$r 1 r 2 = EE \{ AA / {( AE / 2 )}^{2} \} \qquad Formula ( 2 )$$

In Formula (2), a total of peak areas AA, AE, and EE is defined as 100 mol %, where the peak area AA is derived from a portion in which monomer units are bonded in the order of an α-olefin unit and an α-olefin unit, the peak area AE is derived from a portion in which monomer units are bonded in the order of an α-olefin unit and an ethylene unit, and the peak area EE is derived from a portion in which monomer units are bonded in the order of an ethylene unit and an ethylene unit.

The product of monomer reactivity ratios can be determined as follows. A ¹³C-NMR spectrum of the ethylene-α-olefin copolymer (A) is measured using, for example, AvanceNEO 600 (10 mm cryoprobe) manufactured by Bruker Corporation, under the following conditions: measurement solvent: 1,2-dichlorobenzene/1,1,2,2-tetrachloroethane-d2 (85/15 by volume), measurement temperature: 135° C., measurement method: Powergate proton decoupling method, pulse width: 45°, pulse repetition time: 4 seconds, number of accumulations: 256, and chemical shift reference: tetramethylsilane.

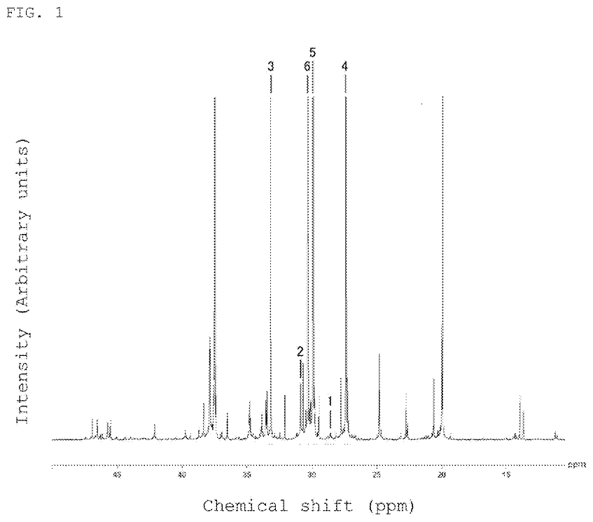

The peak in the measured ¹³C-NMR spectrum can be identified based on methods described in, for example, Kakugo et al., Macromolecules, 15, 1150 (1982), Cheng, Macromolecules, 17, 1950 (1984), Cheng, Macromolecules, 24, 4813 (1991), Wang et al., Macromol. Chem. Phys., 200, 2146 (1999), and Lee et al., Polymer Journal, 28, 696 (1996), and the product r1r2 can be determined from Formula (2). For example, when the α-olefin is propylene, ¹³C-NMR peaks derived from respective carbon atoms are identified as shown in FIG. 1 and in the structural formulas described in Examples, and a peak area PP derived from a portion in which monomer units are bonded in the order of a propylene unit and a propylene unit, a peak area PE derived from a portion in which monomer units are bonded in the order of a propylene unit and an ethylene unit, and a peak area EE derived from a portion in which monomer units are bonded in the order of an ethylene unit and an ethylene unit are determined by the following formulas, and PP, EE, and PE are normalized so that the total of PP, EE, and PE is 100 mol %.

$$PP = T ββ + 1 / 2 T βδ$$

$$EE = 1 / 2 ( S βδ + S δδ ) + 1 / 4 S γδ$$

$$PE = T βδ + 2 T δδ$$

The product r1r2 of monomer reactivity ratios of the ethylene-α-olefin copolymer (that is, a product of an ethylene reactivity ratio r1 and a propylene reactivity ratio r2) is calculated in accordance with the following Formula (3).

$$r 1 r 2 = EE \{ PP / {( PE / 2 )}^{2} \} \qquad Formula ( 3 )$$

When the α-olefin is other than propylene, when two or more α-olefins are used, and when structural units derived from monomers other than ethylene and at least one selected from the group consisting of α-olefins having 3 to 10 carbon atoms are present, r1r2 can also be determined from Formula (2) by reflecting differences in the types of structural units derived from the α-olefin units and from monomers other than ethylene and at least one selected from the group consisting of α-olefins having 3 to 10 carbon atoms, based on the above-described methods and the like.

The mechanism by which the high-speed puncture impact energy of the thermoplastic elastomer composition is reduced by using the ethylene-α-olefin copolymer (A) in which the product r1r2 of monomer reactivity ratios is 1.8 or less is not necessarily clear. However, as described above, the product r1r2 of monomer reactivity ratios is an index indicating a degree of α-olefin chaining in the ethylene-α-olefin copolymer (A). More specifically, a smaller r1r2 indicates fewer α-olefin chains, and a larger r1r2 indicates more α-olefin chains. It is presumed that r1r2 being a predetermined value or less and the α-olefin chaining being a predetermined proportion or less affects higher-order structures, such as semicrystallization of an island phase having the ethylene-α-olefin copolymer (A) as a main component and a crystal grain size distribution, and is presumed to be related to an effect on the high-speed puncture impact energy of the thermoplastic elastomer composition through these higher-order structures.

From the viewpoints of a further reduction in high-speed puncture impact energy and flexibility, the product r1r2 of monomer reactivity ratios is preferably 1.7 or less, more preferably 1.4 or less, still more preferably 1.0 or less, and particularly preferably 0.7 or less.

From the viewpoints of achieving practically preferred impact resistance, increasing a molecular weight during polymerization, and improving mechanical properties, the product r1r2 of monomer reactivity ratios is preferably 0.01 or more, more preferably 0.4 or more, and particularly preferably 0.6 or more.

The product r1r2 of monomer reactivity ratios of the ethylene-α-olefin copolymer (A) can be adjusted by appropriately adjusting production conditions of the ethylene-α-olefin copolymer (A), such as a polymerization temperature, a catalyst, a solvent, monomer dispersibility in a polymerization vessel, and/or hydrogen as a molecular weight modifier. As an example, when a Ziegler-Natta catalyst described below is selected as the catalyst, the product r1r2 of monomer reactivity ratios of the obtained ethylene-α-olefin copolymer tends to generally become smaller.

In addition, as described above, a smaller r1r2 indicates fewer α-olefin chains, whereas a larger r1r2 indicates more α-olefin chains. An ethylene-α-olefin copolymer having higher randomness tends to have a smaller r1r2, and an ethylene-α-olefin copolymer having higher blockiness tends to have a larger r1r2. In the technical field of producing ethylene-α-olefin copolymers, techniques for producing random copolymers and block copolymers have been established, and extensive knowledge has been accumulated by those skilled in the art regarding conditions for producing copolymers having higher randomness and conditions for producing copolymers having higher blockiness. Therefore, by applying such knowledge, those skilled in the art can produce an ethylene-α-olefin copolymer having a desired product r1r2 of monomer reactivity ratios, without undue trial and error, and can use it as the ethylene-α-olefin copolymer (A).

The product r1r2 of monomer reactivity ratios of the ethylene-α-olefin copolymer (A) can be measured, as described above, by techniques established in this technical field, including 13C-NMR measurement, separation of NMR peaks and calculation of peak areas, and structural analysis based thereon. Therefore, those skilled in the art can, without undue trial and error, measure the product r1r2 of monomer reactivity ratios of available ethylene-α-olefin copolymers, including commercially available products, select an ethylene-α-olefin copolymer having a desired r1r2, and use the selected copolymer as the ethylene-α-olefin copolymer (A).

In addition, as described above, an ethylene-α-olefin copolymer having higher randomness tends to have a smaller r1r2, and an ethylene-α-olefin copolymer having higher blockiness tends to have a larger r1r2. Thus, in view of this, it is possible to select, with a certain degree of accuracy, from available ethylene-α-olefin copolymers those likely to have a desired r1r2. As a result, the need to actually measure r1r2 is reduced to a considerable extent. From this viewpoint as well, those skilled in the art can select an ethylene-α-olefin copolymer having a desired product r1r2 of monomer reactivity ratios, without undue trial and error, and can use the selected copolymer as the ethylene-α-olefin copolymer (A).

There are no particular limitations on the peak area AA derived from a portion in which monomer units are bonded in the order of an α-olefin unit and an α-olefin unit, the peak area AE derived from a portion in which monomer units are bonded in the order of an α-olefin unit and an ethylene unit, and the peak area EE derived from a portion in which monomer units are bonded in the order of an ethylene unit and an ethylene unit; however, in order to more effectively achieve the effect of the present invention of reducing high-speed puncture impact energy, the peak area AA derived from a portion in which monomer units are bonded in the order of an α-olefin unit and an α-olefin unit is preferably 8.5 mol or less (provided that a total of peak areas AA, AE, and EE is defined as 100 molo, where the peak area AA is derived from a portion in which monomer units are bonded in the order of an α-olefin unit and an α-olefin unit, the peak area AE is derived from a portion in which monomer units are bonded in the order of an α-olefin unit and an ethylene unit, and the peak area EE is derived from a portion in which monomer units are bonded in the order of an ethylene unit and an ethylene unit).

The molar fraction of peak area AA derived from a portion in which monomer units are bonded in the order of an α-olefin unit and an α-olefin unit in the ethylene-α-olefin copolymer (A) is more preferably 7.0 mol % or less, still more preferably 5.5 mol % or less, and particularly preferably 4.0 mol % or less.

The molar fraction of peak area AA derived from a portion in which monomer units are bonded in the order of an α-olefin unit and an α-olefin unit in the ethylene-α-olefin copolymer (A) is preferably 1.0 mol % or more, more preferably 3.0 mol % or more.

The molar fraction of peak area EE derived from a portion in which monomer units are bonded in the order of an ethylene unit and an ethylene unit in the ethylene-α-olefin copolymer (A) can be appropriately adjusted by a method similar to the method for adjusting the product r1r2 of monomer reactivity ratios described above. In addition, it can also be appropriately adjusted by adjusting the ratio of structural units derived from ethylene in all structural units of the ethylene-α-olefin copolymer (A).

Preferred examples of the ethylene-α-olefin copolymer (A) include the following ethylene random copolymer (A-1) and the following ethylene random copolymer (A-2).

The ethylene random copolymer (A-1) (hereinafter, also referred to as a component (A-1)) is an ethylene random copolymer having structural units derived from ethylene in an amount of 55 mass % or more and less than 80 mass % and structural units derived from at least one monomer selected from the group consisting of α-olefins having 3 to 10 carbon atoms, and having a gel fraction of more than 10 mass % (provided that a total amount of the ethylene random copolymer is 100 mass %). The component (A-1) may have structural units derived from monomers other than ethylene and at least one selected from the group consisting of α-olefins having 3 to 10 carbon atoms. Specific examples of the α-olefin having 3 to 10 carbon atoms in the component (A-1), preferred ranges of a ratio of structural units derived from ethylene in the component (A-1), preferred ranges of a ratio of structural units derived from at least one selected from the group consisting of α-olefins having 3 to 10 carbon atoms, specific examples of structural units derived from monomers other than ethylene and at least one selected from the group consisting of α-olefins having 3 to 10 carbon atoms, preferred ranges of a ratio of such other monomers, and specific examples of the ethylene random copolymer are the same as those described above for the ethylene-α-olefin copolymer (A).

As the ethylene random copolymer has more crosslinked structures, the gel fraction becomes larger.

The component (A-1) can be obtained, for example, by crosslinking a component (A-2) described below. A gel fraction of the component (A-1) can be determined by the following method from the following gel mass of a thermoplastic elastomer composition containing the component (A-1) and a mass of the component (A-2) contained in raw materials of the thermoplastic elastomer composition.

The gel fraction of the component (A-1) is determined by the method described below using a Soxhlet extractor in which an extraction tube is connected to a lower portion of a reflux condenser and a flask is connected to a lower portion of the extraction tube. About 1 g of the thermoplastic elastomer composition and an empty mesh basket made of a wire mesh (opening: 400 mesh) are each weighed. The mesh basket enclosing the thermoplastic elastomer composition is introduced into the extraction tube. 300 ml of o-xylene is introduced into the flask. The flask is heated, and extraction is performed by refluxing o-xylene for 24 hours. After the extraction, the mesh basket containing the extraction residue is removed from the test tube, and dried under reduced pressure at 100° C. using a vacuum dryer, and the dried mesh basket containing the extraction residue is weighed. A gel mass of the thermoplastic elastomer composition is calculated from a mass difference between the dried mesh basket containing the extraction residue and the empty mesh basket. The gel fraction (mass %) of the component (A-1) is calculated based on the following equation.

$$Gel fraction of component ( A - 1 ) = ( gel mass of thermoplastic elastomer composition / mass of component ( A - 2 ) ) \times 100$$

The gel fraction of the component (A-1) is preferably 20 mass % or more and more preferably 40 mass % or more.

As the ethylene random copolymer has more crosslinked structures, the gel fraction of the thermoplastic elastomer composition also becomes larger.

A gel fraction of the thermoplastic elastomer composition can be calculated from a gel mass of the thermoplastic elastomer composition determined by the same method as described above, by the following equation.

$$Gel fraction of thermoplastic elastomer composition = ( gel mass of thermoplastic elastomer composition / mass of thermoplastic elastomer composition ) \times 100$$

The gel fraction of the thermoplastic elastomer composition is preferably 10 mass % or more and 90 mass % or less, more preferably 15 mass % or more and 60 mass % or less, still more preferably 18 mass % or more and 40 mass or less.

The component (A-1) can be obtained by crosslinking a component (A-2) described below. Examples of a method for crosslinking include a method of melt-kneading a composition containing the component (A-2) and a crosslinking agent (D) described below. Crosslinking may be performed simultaneously when producing the thermoplastic elastomer composition of the present invention. In this case, a thermoplastic elastomer composition containing the component (A-1) and the propylene-based polymer (B) can be produced by melt-kneading a composition containing the component (A-2), a propylene-based polymer (B) described below, and a crosslinking agent (D), and details are as described below.

The ethylene random copolymer (A-2) (hereinafter, also referred to as a component (A-2)) is an ethylene random copolymer having structural units derived from ethylene in an amount of 55 mass % or more and less than 80 mass % and structural units derived from at least one monomer selected from the group consisting of α-olefins having 3 to 10 carbon atoms, and having a gel fraction of 10 mass % or less (provided that a total amount of the ethylene random copolymer is 100 mass %). The component (A-2) may have structural units derived from monomers other than ethylene and at least one selected from the group consisting of α-olefins having 3 to 10 carbon atoms. Specific examples of the α-olefin having 3 to 10 carbon atoms in the component (A-2), preferred ranges of a ratio of structural units derived from ethylene in the component (A-2), preferred ranges of a ratio of structural units derived from at least one selected from the group consisting of α-olefins having 3 to 10 carbon atoms, specific examples of structural units derived from monomers other than ethylene and at least one selected from the group consisting of α-olefins having 3 to 10 carbon atoms, preferred ranges of a ratio of such other monomers, and specific examples of the ethylene random copolymer are the same as those in the case of the ethylene-α-olefin copolymer (A).

A gel fraction of the component (A-2) is preferably 5 mass % or less and more preferably 1 mass % or less. The component (A-2) preferably substantially has no crosslinked structure.

A Mooney viscosity (ML₁₊₄ at 125° C.) of the component (A-2) as measured at 125° C. is preferably 5 or more and 350 or less, more preferably 10 or more and 300 or less, still more preferably 40 or more and 200 or less. The Mooney viscosity (ML₁₊₄ at 125° C.) is measured in accordance with JIS K6300, and “ML₁₊₄ at 125° C.” has the following meaning.
M: Mooney viscosity
L: Using large rotor
125° C.: Measurement temperature
1+4: Measured value when, after heating a sample for 1 minute, the rotor is rotated at 2 rpm for 4 minutes

When the component (A-2) and mineral oil (hereinafter, also referred to as a component (C)) are mixed in advance, the Mooney viscosity (ML₁₊₄ at 125° C.) of the ethylene random copolymer can be calculated from the following Equation (1).

$$log ( ML 1 / ML 2 ) = 0.0066 ( Δ PHR ) \qquad ( 1 )$$

ML1: Mooney viscosity of ethylene random copolymer
ML2: Mooney viscosity of a mixture of the ethylene random copolymer and the component (C)
ΔPHR: Ratio of the component (C) to 100 parts by mass of the ethylene random copolymer

The component (A-2) may be produced by a known method, or a commercially available product may be used. Examples of a method for producing the component (A-2) include a method of copolymerizing ethylene and at least one monomer selected from the group consisting of α-olefins having 3 to 10 carbon atoms in the presence of a known complex catalyst, such as a Ziegler-Natta catalyst, a metallocene-based complex, or a non-metallocene-based complex. The component (A-2) may have structural units derived from monomers other than ethylene and at least one selected from the group consisting of α-olefins having 3 to 10 carbon atoms, for example, a non-conjugated diene.

Examples of the polymerization method include a slurry polymerization method, a solution polymerization method, a bulk polymerization method, and a gas-phase polymerization method. Preferred examples of an inert hydrocarbon solvent used in solution polymerization and slurry polymerization include propane, butane, isobutane, pentane, hexane, heptane, and octane. These polymerization methods may be used in combination of two or more, and may be either a batch process or a continuous process.

### (B) Propylene-Based Polymer

The thermoplastic elastomer composition of the present invention contains (B) a propylene-based polymer.

The propylene-based polymer (B) contained in the thermoplastic elastomer composition according to the present invention (hereinafter, also referred to as a component (B)) is a propylene (co) polymer having structural units derived from propylene in an amount of more than 50 mass % and 100 mass % or less. The component (B) may have structural units derived from monomers other than propylene.

Since the component (B) has structural units derived from propylene in an amount of 50 mass % or more, the component (B) is a non-crosslinkable or degradable polymer as compared with the component (A), and is suitable for constituting a sea phase of a sea-island structure of the thermoplastic elastomer composition of the present invention.

Examples of monomers other than propylene include ethylene and α-olefins having 4 or more carbon atoms, and ethylene and α-olefins having 4 to 20 carbon atoms are preferred.

Examples of the α-olefins having 4 to 20 carbon atoms include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 4-methyl-1-pentene, 2-ethyl-1-hexene, and 2,2,4-trimethyl-1-pentene. The monomers other than propylene may be used alone or two or more thereof may be used.

The ratio of structural units derived from propylene, the ratio of structural units derived from ethylene, and the ratio of structural units derived from at least one monomer selected from the group consisting of α-olefins having 4 or more carbon atoms in the propylene-based polymer (B) can be determined by the same method as that used for determining the ratios of the respective structural units in the ethylene-α-olefin copolymer (A).

There are no particular limitations on the structure of the propylene-based polymer (B), and examples thereof include a propylene homopolymer, a propylene random copolymer, and a heterophasic propylene polymer material. The thermoplastic elastomer composition according to the present invention may contain only one propylene-based polymer (B), or may contain two or more propylene-based polymers (B).

The propylene-based polymer (B) may be produced by a known method, or a commercially available product may be used. Examples of a method for producing the propylene-based polymer include a method of polymerizing propylene (and, as needed, other monomers) in the presence of a Ziegler-Natta catalyst or a complex catalyst, such as a metallocene complex or a non-metallocene complex. Examples of the polymerization method include a slurry polymerization method, a solution polymerization method, a bulk polymerization method, and a gas-phase polymerization method. Preferred examples of an inert hydrocarbon solvent used in solution polymerization and slurry polymerization include propane, butane, isobutane, pentane, hexane, heptane, and octane. These polymerization methods may be used in combination of two or more, and may be either a batch process or a continuous process. In production of a heterophasic propylene polymer material, a polymerization method is preferably continuous gas-phase polymerization, or bulk-gas-phase polymerization in which bulk polymerization and gas-phase polymerization are continuously performed.

In the present specification, the term “heterophasic propylene polymer material” means a mixture having a structure in which a copolymer (II) (provided that a total mass of the copolymer is 100 mass %) (hereinafter, also simply referred to as a “copolymer (II)”) is dispersed in a matrix of a polymer (I) having structural units derived from propylene in an amount of more than 80 mass % and 100 mass % or less (provided that a total mass of the polymer is 100 mass %) (hereinafter, also simply referred to as a “polymer (I)”), the copolymer (II) having structural units derived from ethylene in an amount of 20 mass % or more and 90 mass % or less, and structural units derived from propylene and structural units derived from at least one monomer selected from the group consisting of α-olefins having 4 or more carbon atoms.

The heterophasic propylene polymer material as the component (B) has structural units derived from propylene in an amount of 50 mass % or more based on 100 mass % of a total amount of the heterophasic propylene polymer material.

The amount of the polymer (I) contained in the heterophasic propylene polymer material is preferably 60 mass % or more and 90 mass % or less, and more preferably 75 mass % or more and 85 mass % or less (provided that a total amount of the heterophasic propylene polymer material (C2) is 100 mass %). The amount of the copolymer (II) contained in the heterophasic propylene polymer material (C2) is preferably 10 mass % or more and 40 mass % or less, and more preferably 15 mass % or more and 25 mass % or less (provided that a total amount of the heterophasic propylene polymer material is 100 mass %).

In the copolymer (II), the α-olefin having 4 or more carbon atoms is preferably an α-olefin having 4 to 20 carbon atoms, and examples of the α-olefin having 4 to 20 carbon atoms are the same as the above-described monomers other than propylene. In the copolymer (II), the α-olefin having 4 or more carbon atoms may be used alone or two or more thereof may be used in combination.

A ratio of structural units derived from ethylene contained in the copolymer (II) is preferably 22 mass % or more and 80 mass % or less, more preferably 25 mass % or more and 70 mass % or less, and still more preferably 27 mass % or more and 60 mass % or less (provided that a total amount of structural units derived from propylene, structural units derived from at least one selected from the group consisting of α-olefins having 4 or more carbon atoms, and structural units derived from ethylene is 100 mass %). A ratio of structural units derived from propylene and structural units derived from at least one monomer selected from the group consisting of α-olefins having 4 or more carbon atoms contained in the copolymer (II) is preferably 20 mass % or more and 78 mass % or less, more preferably 30 mass % or more and 75 mass % or less, and still more preferably 40 mass % or more and 73 mass % or less (provided that a total amount of structural units derived from propylene, structural units derived from at least one monomer selected from the group consisting of α-olefins having 4 or more carbon atoms, and structural units derived from ethylene is 100 mass %).

Preferred examples of the copolymer (II) include a propylene-ethylene copolymer, an ethylene-1-butene copolymer, an ethylene-1-hexene copolymer, an ethylene-1-octene copolymer, a propylene-ethylene-1-butene copolymer, a propylene-ethylene-1-hexene copolymer, and a propylene-ethylene-1-octene copolymer, and a propylene-ethylene copolymer is preferred. The copolymer (II) is usually a random copolymer.

A melt flow rate (MFR) of the propylene-based polymer (B) as measured in accordance with JIS K7210 under conditions of a temperature of 230° C. and a load of 21.18 N is preferably 0.3 g/10 min or more and 200 g/10 min or less from the viewpoints of moldability and mechanical properties. The melt flow rate of the propylene-based polymer (B) is more preferably 2.5 g/10 min or more and 105 g/10 min or less.

An intrinsic viscosity (hereinafter, referred to as [η_{cxis}]) of a portion insoluble in xylene at 20° C. (hereinafter, referred to as a CXIS portion) of the propylene-based polymer (B) is preferably 0.1 dl/g or more and 6.0 dl/g or less, more preferably 0.3 dl/g or more and 5.0 dl/g or less, and still more preferably 1.0 dl/g or more and 3.5 dl/g or less.

The intrinsic viscosity (hereinafter, referred to as [η_{cxs}]) of a portion soluble in xylene at 20° C. (hereinafter, referred to as a CXS portion) of the heterophasic propylene polymer material is preferably 1.0 dl/g or more and 6.0 dl/g or less.

The intrinsic viscosity can be determined in accordance with the following procedure. A reduced viscosity is measured in tetralin at 135° C. using an Ubbelohde viscometer, and the intrinsic viscosity is determined by an extrapolation method from the obtained reduced viscosity in accordance with the calculation method described on page 491 of “Polymer Solutions, Polymer Experimental Studies 11” (published in 1982 by Kyoritsu Shuppan Co., Ltd.).

Here, the CXS portion and the CXIS portion can be obtained by the following method. About 5 g of the propylene-based polymer (B) is completely dissolved in 500 ml of boiling xylene. The obtained xylene solution is gradually cooled to 20° C. and conditioned at 20° C. for 4 hours or longer, and the precipitate and the solution are separated by filtration. The precipitate is the CXIS portion. A material obtained by removing the solvent from the solution is a xylene-soluble portion at 20° C. (CXS portion).

As the propylene-based polymer (B), a propylene homopolymer, a propylene-ethylene random copolymer, a propylene-ethylene-1-butene random copolymer, or a heterophasic propylene polymer material is preferred, a propylene homopolymer or a heterophasic propylene polymer material is more preferred, and a propylene homopolymer is still more preferred.

### (C) Mineral Oil

The thermoplastic elastomer composition of the present invention may contain (C) mineral oil.

The mineral oil (C) may be mixed with the ethylene-α-olefin copolymer (A); that is, the ethylene-α-olefin copolymer (A) may be oil-extended with the mineral oil (C).

In the present embodiment, examples of the mineral oil (C) preferably used as a softening agent include high-boiling petroleum fractions (having an average molecular weight of 300 to 1,500 and a pour point of 0° C. or lower) such as aromatic mineral oils, naphthenic mineral oils, and paraffinic mineral oils. Among these, a paraffinic mineral oil is preferred.

The mineral oil (C) is preferably added, as an extending oil, to the ethylene-α-olefin copolymer (A), particularly preferably to an ethylene-α-olefin-non-conjugated diene copolymer. The method of such addition may be a known method, and examples thereof include: (1) a method of mechanically kneading the two components using a kneading apparatus such as rolls or a Banbury mixer; and (2) a method of adding the component (C) to a solution of the component (A) produced in a solution form, and then removing the solvent by a method such as steam stripping.

When the mineral oil (C) is compounded as an extending oil for the ethylene-α-olefin copolymer (A), a Mooney viscosity (ML₁₊₄ at 125° C.) of a composition (oil-extended polymer) composed of the mineral oil (C) and the ethylene-α-olefin copolymer (A) as measured at 125° C. is preferably 5 or more and 300 or less, more preferably 10 or more and 250 or less, and still more preferably 40 or more and 200 or less. The Mooney viscosity (ML₁₊₄ at 125° C.) is measured in accordance with JIS K6300.

From the viewpoint of achieving the above Mooney viscosity, the amount of the mineral oil (C) is preferably 20 parts by mass to 110 parts by mass, more preferably 25 parts by mass to 80 parts by mass, and still more preferably 30 parts by mass to 60 parts by mass, based on 100 parts by mass as a total amount of the ethylene-α-olefin copolymer (A) and the mineral oil (C).

### (D) Crosslinking Agent

In the thermoplastic elastomer composition of the present invention, a sea-island structure is preferably formed. For this purpose, it is preferable to produce the thermoplastic elastomer composition through melt-kneading, in the presence of the crosslinking agent (D), a mixture containing the ethylene-α-olefin copolymer (A) and the propylene-based polymer (B).

Examples of the crosslinking agent (D) preferably used in the present embodiment include crosslinking agents commonly used for crosslinking rubber, and include organic peroxides, phenolic resins, sulfur, sulfur-containing compounds, p-quinone, derivatives of p-quinone dioxime, bismaleimide compounds, epoxy compounds, silane compounds, and amino resins. Among these, organic peroxides and phenolic resins are preferred.

Examples of the organic peroxide include ketone peroxides, diacyl peroxides, hydroperoxides, dialkyl peroxides, peroxyketals, alkyl peresters, percarbonates, peroxydicarbonates, and peroxyesters.

Specific examples of the organic peroxide include dicumyl peroxide, 2,5-dimethyl-2,5-di(tert-butylperoxy) hexane, 2,5-dimethyl-2,5-di(tert-butylperoxy) hexyne, 1,3-bis(tert-butylperoxyisopropyl)benzene, tert-butyl cumyl peroxide, di-tert-butyl peroxide, 2,2,4-trimethylpentyl-2-hydroperoxide, diisopropylbenzene hydroperoxide, cumene peroxide, tert-butyl peroxide, 1,1-di(tert-butylperoxy)-3,5,5-trimethylcyclohexane, 1,1-di-tert-butylperoxycyclohexane, isobutyl peroxide, 2,4-dichlorobenzoyl peroxide, o-methylbenzoyl peroxide, bis-3,5,5-trimethylhexanoyl peroxide, lauroyl peroxide, benzoyl peroxide, and p-chlorobenzoyl peroxide. Among these, 2,5-dimethyl-2,5-di(tert-butylperoxy) hexane and 2,5-dimethyl-2,5-di(tert-butylperoxy) hexyne are preferred.

The organic peroxide may be used alone or two or more thereof may be used.

The organic peroxide used in the present embodiment may be in any form of a liquid, a powder, or pellets. In addition, in order to improve dispersibility, it is more preferable to use the organic peroxide after diluting the organic peroxide with an inorganic filler or a mineral diluent that is inert to a crosslinking reaction, such as an oil or a solvent. In addition, the method of addition is also more preferably addition in a liquid state. Among these, a paraffinic oil is a preferred diluent in consideration of its handleability and its influence on products.

In order to allow the crosslinking reaction to proceed uniformly and gently, the organic peroxide may be used in combination with a crosslinking coagent. As the crosslinking coagent, a polyfunctional compound such as a sulfur-based compound, a methacrylate-based compound, or a maleimide-based compound can be compounded. Examples of the crosslinking coagent include sulfur, p-quinone dioxime, p, p′-dibenzoylquinone dioxime, ethylene glycol dimethacrylate, diethylene glycol dimethacrylate, triethylene glycol dimethacrylate, tetraethylene glycol dimethacrylate, polyethylene glycol dimethacrylate, trimethylolpropane trimethacrylate, diallyl phthalate, tetraallyloxyethane, triallyl isocyanurate, N,N′-m-phenylenebismaleimide, maleic anhydride, divinylbenzene, zinc diacrylate, and zinc dimethacrylate. Among these, N,N′-m-phenylenebismaleimide, p, p′-dibenzoylquinone dioxime, divinylbenzene, trimethylolpropane trimethacrylate, or triallyl isocyanurate is preferred. N,N′-m-phenylenebismaleimide may also be used alone as a crosslinking agent.

There are no particular limitations on the amount of the crosslinking agent (D), and those skilled in the art can appropriately set the amount of the crosslinking agent (D) suitable for crosslinking the ethylene-α-olefin copolymer (A) to a desired level.

Since the crosslinking agent (D) may decompose in a process for crosslinking the ethylene-α-olefin copolymer (A), including melt-kneading, a suitable amount of the crosslinking agent (D) is generally specified not by an amount of the crosslinking agent (D) remaining in the thermoplastic elastomer composition of the present invention, but by an amount of the crosslinking agent (D) before melt-kneading the ethylene-α-olefin copolymer (A) and the propylene-based polymer (B) in the presence of the crosslinking agent (D).

An amount of the crosslinking agent (D) before melt-kneading is preferably 0.001 parts by mass or more and 3.0 parts by mass or less, more preferably 0.01 parts by mass or more and 2.0 parts by mass or less, and still more preferably 0.3 parts by mass or more and 1.0 part by mass or less, based on 100 parts by mass as a total amount of the ethylene-α-olefin copolymer (A) and the propylene-based polymer (B).

When a crosslinking coagent is used together with the crosslinking agent (D), an amount of the crosslinking coagent before melt-kneading is preferably 0.01 parts by mass or more and 10 parts by mass or less, and more preferably 0.5 parts by mass or more and 1.0 part by mass or less, based on 100 parts by mass as a total amount of the ethylene-α-olefin copolymer (A) and the propylene-based polymer (B).

### (E) Inorganic Filler

The thermoplastic elastomer composition of the present invention may contain (E) an inorganic filler.

By containing the inorganic filler (E), the thermoplastic elastomer composition of the present embodiment can have excellent properties including mechanical strength and dimensional stability.

Examples of the inorganic filler include talc, clay, calcium carbonate, barium carbonate, magnesium carbonate, zinc carbonate, calcium sulfate, barium sulfate, magnesium sulfate, zinc oxide, iron oxide, calcium oxide, magnesium oxide, aluminum oxide, titanium oxide, barium oxide, calcium silicate, calcined kaolin, glass fibers, hollow glass spheres, zeolite, silica, diatomaceous earth, asbestos, metal soaps, titanium dioxide, mica, and potassium titanate fibers. Among these, calcium carbonate, talc, silica, or clay can be preferably used, and calcium carbonate can be more preferably used. The inorganic filler (E) may be used alone or two or more thereof may be used.

There are no particular limitations on the amount of the inorganic filler (E); however, the inorganic filler (E) can be used, for example, in an amount of 50 parts by mass or less, preferably 1 part by mass or more and 40 parts by mass or less, and particularly preferably 10 parts by mass or more and 20 parts by mass or less, based on 100 parts by mass as a total amount of the ethylene-α-olefin copolymer (A) and the propylene-based polymer (B).

### (F) Ethylene-Based Resin

The thermoplastic elastomer composition of the present invention may contain (F) an ethylene-based resin having a ratio of structural units derived from ethylene of 80 mass % or more (hereinafter, also referred to as “(F) component”).

By further containing (F) an ethylene-based resin having a ratio of structural units derived from ethylene of 80 mass % or more, the thermoplastic elastomer composition of the present embodiment can have excellent properties including high rigidity and durability.

When the thermoplastic elastomer composition of the present embodiment is produced by a production method including melt-kneading in two stages, rigidity and fluidity of the thermoplastic elastomer composition can be improved more effectively by adding the component (F) during the second melt-kneading. In this case, it is preferable not to add the crosslinking agent (D) during the second melt-kneading.

From the viewpoint of mechanical properties, the ethylene-based resin (F) having a ratio of structural units derived from ethylene of 80 mass % or more preferably has a ratio of structural units derived from ethylene of 90 mass % or more, and more preferably 95 mass % or more.

The component (F) may have, in addition to structural units derived from ethylene, structural units derived from at least one monomer selected from the group consisting of α-olefins having 3 to 10 carbon atoms. Examples of the α-olefins having 3 to 10 carbon atoms include propylene, 1-butene, 2-methylpropene, 1-pentene, 3-methyl-1-butene, 1-hexene, 3-methyl-1-pentene, 4-methyl-1-pentene, 1-heptene, 1-octene, 1-nonene, 1-decene, and cyclic olefins such as vinylcyclohexane.

The component (F) may have structural units derived from two or more α-olefins having 3 to 10 carbon atoms. Preferred examples of the structural units derived from at least one selected from the group consisting of α-olefins having 3 to 10 carbon atoms in the component (F) include a structural unit derived from propylene, a structural unit derived from 1-butene, a structural unit derived from 4-methyl-1-pentene, a structural unit derived from 1-hexene, or a structural unit derived from 1-octene. The component (F) may have structural units derived from monomers other than ethylene and α-olefins having 3 to 10 carbon atoms.

There are no particular limitations on a density of the component (F); however, from the viewpoint of improving mechanical properties and rigidity of the thermoplastic elastomer composition, the density is preferably 950 kg/m³ or more, more preferably 955 kg/m³ or more, and particularly preferably 960 kg/m³ or more.

From the viewpoint of light weight, the density of the component (F) is preferably 1,000 kg/m³ or less.

There are no particular limitations on an MFR of the component (F); however, from the viewpoint of fluidity, an MFR as measured at 190° C. under a load of 21.18 N is preferably 0.1 g/10 min or more, more preferably 1 g/10 min or more, and particularly preferably 10 g/10 min or more.

From the viewpoint of surface smoothness of a molded article, the MFR of the component (F) as measured at 190° C. under a load of 21.18 N is preferably 100 g/10 min or less, more preferably 50 g/10 min or less, and particularly preferably 20 g/10 min or less.

There are no particular limitations on the amount of the component (F); however, from the viewpoints of rigidity and durability, the amount is preferably 10 parts by mass or more, more preferably 30 parts by mass or more, and particularly preferably 60 parts by mass or more, based on 100 parts by mass of the ethylene-α-olefin copolymer (A).

From the viewpoint of flexibility, the amount of the component (F) is preferably 200 parts by mass or less, more preferably 100 parts by mass or less, and particularly preferably 70 parts by mass or less, based on 100 parts by mass of the ethylene-α-olefin copolymer (A).

### Other Components

The thermoplastic elastomer composition of the present invention may contain, in addition to the essential components, the ethylene-α-olefin copolymer (A) and the propylene-based polymer (B), and the above-described preferred components, the mineral oil (C), the crosslinking agent (D), the inorganic filler (E), and the ethylene-based resin (F) having a ratio of structural units derived from ethylene of 80 mass % or more, various components and additives other than these components.

As various components and additives, the thermoplastic elastomer composition of the present invention may contain, for example, a polymer or an oligomer other than the components (A), (B), and (F); a lubricant; a softening agent other than the mineral oil (C); an organic filler (for example, fibers, wood flour, cellulose powder, carbon fibers, graphite, and carbon black); an antioxidant (for example, a phenolic antioxidant, a sulfur-based antioxidant, a phosphorus-based antioxidant, a lactone-based antioxidant, and a vitamin-based antioxidant); a weathering stabilizer; an ultraviolet absorber (for example, a benzotriazole-based ultraviolet absorber, a triazine-based ultraviolet absorber, an anilide-based ultraviolet absorber, and a benzophenone-based ultraviolet absorber); a heat stabilizer; a light stabilizer (for example, a hindered amine-based light stabilizer and a benzoate-based light stabilizer); a pigment (for example, an inorganic pigment, an organic pigment, and a pigment dispersant); a nucleating agent; a foaming agent; a foam nucleating agent; a plasticizer; a flame retardant; a brightness enhancer; an antibacterial agent; a light diffusing agent; an adsorbent; a metal oxide (for example, zinc oxide and magnesium oxide); a wetting and dispersing agent; a VOC and odor stripping agent; a water-retention agent (for example, an aqueous medium containing an amphiphilic polymer); a scratch resistance improver; a metal chloride (for example, iron chloride and calcium chloride); hydrotalcite; a lubricant (for example, a hydrocarbon-based lubricant, a fatty acid-based lubricant, a fatty acid amide-based lubricant, an ester-based lubricant, an alcohol-based lubricant, a metal soap-based lubricant, a silicone-based lubricant, for example silicone oil, silicone gum, and an inorganic lubricant); and an aluminate salt. These components and additives may be used alone or two or more thereof may be used in combination.

Examples of resins other than the components (A) to (C) include an olefin-based resin (excluding those corresponding to the components (A), (B), and (F)), an olefin-based elastomer (excluding those corresponding to the components (A), (B), and (F)), an aromatic vinyl/conjugated diene copolymer (a copolymer having structural units derived from an aromatic vinyl compound and structural units derived from a conjugated diene compound), a polyphenylene ether-based resin, a polyamide-based resin, a polyester-based resin, a polyoxymethylene-based resin, and a polymethyl methacrylate-based resin.

Examples of the aromatic vinyl/conjugated diene copolymer (a copolymer having structural units derived from an aromatic vinyl compound and structural units derived from a conjugated diene compound) include an aromatic vinyl compound-conjugated diene compound polymer, an aromatic vinyl compound-conjugated diene compound-aromatic vinyl compound polymer, and hydrogenated products thereof. Among these, a hydrogenated product of an aromatic vinyl compound-conjugated diene compound-aromatic vinyl compound polymer can be preferably used.

### Thermoplastic Elastomer Composition

The thermoplastic elastomer composition of the present invention contains 100 parts by mass of the ethylene-α-olefin copolymer (A) and 20 parts by mass to 90 parts by mass of the propylene-based polymer (B).

With the above compounding ratio, the thermoplastic elastomer composition of the present invention can readily form a sea-island structure in which an island phase mainly composed of the ethylene-α-olefin copolymer (A) is dispersed in a sea phase mainly composed of the propylene-based polymer (B), and has physical properties as a thermoplastic elastomer composition including thermoplasticity and rubber elasticity, and also satisfies the other requirements of the present invention, thereby achieving the effect of the present invention that a molded article excellent in split-open performance can be produced.

From the viewpoints of moldability and mechanical properties, the thermoplastic elastomer composition of the present invention preferably contains the propylene-based polymer (B) in an amount of 25 parts by mass or more, and more preferably 30 parts by mass or more, based on 100 parts by mass of the ethylene-α-olefin copolymer (A).

On the other hand, from the viewpoint of flexibility, the thermoplastic elastomer composition of the present invention preferably contains the propylene-based polymer (B) in an amount of 70 parts by mass or less, and more preferably 50 parts by mass or less, based on 100 parts by mass of the ethylene-α-olefin copolymer (A).

The thermoplastic elastomer composition of the present invention may contain carbon-14 (¹⁴C) as a constituent element, and may be a material-recycled (mechanically recycled) thermoplastic elastomer composition.

A concentration of carbon-14 (¹⁴C) contained in the thermoplastic elastomer composition is determined as pMC (percentage of modern carbon, unit: %) by an accelerator mass spectrometry (AMS) method specified in ISO 16620-2:2019.

Since carbon dioxide in the atmosphere contains carbon-14 (¹⁴C) at a certain ratio, it is known that plants that take in atmospheric carbon dioxide and grow, for example, corn and trees, contain ¹⁴C. It is also known that petroleum and other fossil resources, which are considered to have been stored underground for a long period of time, contain almost no carbon-14 (¹⁴C). Therefore, by using plant-derived materials as monomer raw materials for the ethylene copolymer as component (A), the copolymer having structural units derived from an aromatic vinyl compound and structural units derived from a conjugated diene compound as component (B), the propylene-based polymer as component (B), and/or the mineral oil as component (C) used in the thermoplastic elastomer composition, carbon-14 (¹⁴C) can be contained in the constituent elements of the thermoplastic elastomer.

In production of the ethylene-α-olefin copolymer as the component (A) and/or the propylene-based polymer as the component (B), the optional mineral oil as the component (C), and/or the ethylene-based resin as the component (F) having a ratio of structural units derived from ethylene of 80 mass % or more, which are used in the thermoplastic elastomer composition, for example, a fossil resource-derived monomer (for example, ethylene, propylene, 1-butene, and 1-hexene), a plant-derived monomer (for example, ethylene, propylene, 1-butene, and 1-hexene), and a chemically recycled monomer (for example, ethylene, propylene, 1-butene, and 1-hexene) can be used, and two or more of these may be used in combination.

Specific examples of combinations of monomers include fossil resource-derived ethylene/plant-derived ethylene/chemically recycled ethylene; fossil resource-derived propylene/plant-derived propylene/chemically recycled propylene; and fossil resource-derived propylene/plant-derived propylene/chemically recycled propylene/fossil resource-derived ethylene/plant-derived ethylene/chemically recycled ethylene.

A fossil resource-derived monomer is derived from carbon as an underground resource such as petroleum, coal, and natural gas, and generally contains almost no carbon-14 (¹⁴C). Examples of a method for producing the fossil resource-derived monomer include known methods, for example, a method of producing an olefin by cracking petroleum-derived naphtha or ethane, and a method of producing an olefin by dehydrogenating ethane or propane.

A plant-derived monomer is derived from carbon that circulates on the earth's surface through animals and plants, and generally contains carbon-14 (¹⁴C) at a certain ratio. Examples of a method for producing the plant-derived monomer include known methods, for example, cracking bionaphtha, vegetable oil, or animal oil; dehydrogenating biopropane; a method in which alcohol is separated from a fermentation product, for example, sugar, extracted from a plant raw material, for example, sugarcane or corn, and the alcohol is then subjected to a dehydration reaction (for example, JP-T-2010-511634, JP-T-2011-506628, JP-T-2013-503647); and a method of subjecting ethylene obtained from plant-derived ethanol and n-butene to metathesis (for example, WO 2007/055361 A).

A chemically recycled monomer is derived from carbon generated by decomposition or combustion of waste, and the amount of carbon-14 (¹⁴C) contained therein varies depending on the waste. Examples of a method for producing the chemically recycled monomer include known methods, for example, a method of thermally decomposing waste plastic (for example, JP-T-2017-512246), a method of cracking waste vegetable oil or waste animal oil (for example, JP-T-2018-522087), and a method of subjecting waste including kitchen waste, biomass waste, food waste, waste oil, waste wood, waste paper, and/or waste plastic to gasification, alcohol conversion, and a dehydration reaction (for example, JP-A-2019-167424 and WO 2021/006245 A).

When two or more of a fossil resource-derived olefin, a plant-derived olefin, and a chemically recycled olefin are used, olefins produced separately may be mixed and used in combinations such as a fossil resource-derived olefin/plant-derived olefin, a fossil resource-derived olefin/chemically recycled olefin, a plant-derived olefin/chemically recycled olefin, and a fossil resource-derived olefin/plant-derived olefin/chemically recycled olefin. In addition, by using, as a raw material or a production intermediate in an olefin production process, a mixture in a combination such as a fossil resource-derived compound/plant-derived compound, a fossil resource-derived compound/chemically recycled compound, a plant-derived compound/chemically recycled compound, or a fossil resource-derived compound/plant-derived compound/chemically recycled compound, an olefin produced as a mixture corresponding to the above-described olefin combinations may also be used.

As the ethylene-α-olefin copolymer (A) containing carbon-14 (¹⁴C), a commercially available ethylene copolymer or an ethylene polymer having monomer units derived from ethylene in an amount of more than 90 mass can be used. Examples thereof include “I'M GREEN” (green polyethylene) series manufactured by Braskem, “TRUCIRCLE” series manufactured by SABIC, and “CirculenRenew” series manufactured by LyondellBasell.

As the propylene-based polymer (B) containing carbon-14 (¹⁴C), a commercially available propylene-based polymer can be used. Examples thereof include “Bornewables” series manufactured by Borealis, “TRUCIRCLE” series manufactured by SABIC, and “CirculenRenew” series manufactured by LyondellBasell.

From the viewpoint of reducing environmental burden, a carbon-14 (¹⁴C) concentration of the thermoplastic elastomer composition is preferably 0.2 pMC % or more, more preferably 0.5 pMC % or more, still more preferably 1 pMC % or more, even more preferably 5 pMC % or more, and particularly preferably 10 pMC % or more. From the viewpoint of cost, the carbon-14 (¹⁴C) concentration is preferably 99 pMC % or less, more preferably 95 pMC % or less, still more preferably 90 pMC % or less, even more preferably 70 pMC % or less, and particularly preferably 50 pMC % or less.

A carbon-14 (¹⁴C) concentration of the thermoplastic elastomer composition can be adjusted by changing ratios of a fossil resource-derived olefin, a plant-derived olefin, and a chemically recycled olefin used for producing the thermoplastic elastomer composition.

There are no particular limitations on the method for producing a thermoplastic elastomer composition of the present invention; however, the thermoplastic elastomer composition can be preferably produced by a production method including kneading (preferably melt-kneading) the ethylene-α-olefin copolymer (A) and the propylene-based polymer (B), which serve as raw materials, and (if desired) various additives including the components (C) to (F). For example, kneading can be performed by a conventional method using a conventional extruder, a Banbury mixer, rolls, a Brabender plastograph, or a kneader Brabender. Production by melt-kneading using an extruder, particularly a twin-screw extruder, is preferred. In addition, all components to be kneaded may be collectively melt-kneaded, or the remaining components may be added and melt-kneaded after kneading some of the components, and melt-kneading may be performed once or two or more times. A temperature during melt-kneading is preferably 150° C. to 300° C., and more preferably 180° C. to 250° C. A time for melt-kneading is preferably 20 seconds to 30 minutes, and more preferably 30 seconds to 20 minutes. The components to be kneaded may be added in any order, or may be added simultaneously.

In producing the thermoplastic elastomer composition of the present invention, crosslinking may be performed, or the thermoplastic elastomer composition may be non-crosslinked. From the viewpoints of control of a sea-island structure and melt viscosity, it is preferable to perform crosslinking.

In a preferred production method when crosslinking is performed, it is preferable to perform melt-kneading the ethylene-α-olefin copolymer (A) and the propylene-based polymer (B) in the presence of the crosslinking agent (D).

When the ethylene-α-olefin copolymer (A) is used, it is preferable that a Mooney viscosity (ML₁₊₄ 125° C.) of the ethylene-α-olefin copolymer (A) is 40 or more, and a melt flow rate of the propylene-based polymer (B) measured under conditions of a temperature of 230° C. and a load of 21.18 N is 0.3 g/10 min to 200 g/10 min.

When the ethylene-α-olefin copolymer (A) is oil-extended with the mineral oil (C), it is preferable to perform melt-kneading, in the presence of the crosslinking agent (D), an oil-extended polymer composed of the mineral oil (C) and the ethylene-α-olefin copolymer (A), and the propylene-based polymer (B). It is preferable that a Mooney viscosity (ML₁₊₄ 125° C.) of the oil-extended polymer is 30 or more, and a melt flow rate of the propylene-based polymer (B) measured under conditions of a temperature of 230° C. and a load of 21.18 N is 0.3 g/10 min to 200 g/10 min.

When melt-kneading is performed two or more times, it is preferable that, in a preceding process, the ethylene-α-olefin copolymer (A) and the propylene-based polymer (B) are melt-kneaded in the presence of the crosslinking agent (D), and that, in a subsequent process, the ethylene-based resin (F) having a ratio of structural units derived from ethylene of 80 mass % or more is added to the melt-kneaded product obtained in the preceding process and the resulting mixture is further melt-kneaded. Performing the subsequent process can further improve rigidity of the resulting thermoplastic elastomer composition.

In the subsequent process, a temperature during melt-kneading is preferably 150° C. to 300° C., and more preferably 180° C. to 250° C. Although there are no particular limitations on a heat treatment time, it is preferably 5 seconds to 30 minutes, and more preferably 10 seconds to 10 minutes.

The subsequent process is preferably performed under conditions in which the crosslinking agent (D) is substantially absent.

The thermoplastic elastomer composition of the present invention achieves a remarkable technical effect having high practical value in that the product r1r2 of monomer reactivity ratios of the ethylene-α-olefin copolymer (A), which is a constituent component thereof, is a predetermined value or less, and the thermoplastic elastomer composition further satisfies the other constituent requirements of the present invention, thereby providing low high-speed puncture impact energy and a resulting molded article having excellent split-open performance.

Although there are no particular limitations on a high-speed puncture impact energy of the thermoplastic elastomer composition of the present invention, in a high-speed puncture impact test performed under conditions of a striker diameter of ½ inch, a striker speed of 2.8 m/s, and a test temperature of 23° C. on an injection-molded article having a length of 150 mm, a width of 90 mm, and a thickness of 2.0 mm, obtained by injection molding the thermoplastic elastomer composition under conditions of a molding temperature of 220° C. and a mold temperature of 50° C., the high-speed puncture impact energy at a puncture point is preferably 12.0 J or less, more preferably 10.9 J or less, still more preferably 10.3 J or less, and particularly preferably 10.0 J or less.

When the high-speed puncture impact energy is the upper limit value or less, a molded article obtained from the thermoplastic elastomer composition has excellent split-open performance, and, for example, when used as a skin material for an automobile instrument panel, the molded article can be easily split open during deployment of an airbag even without tear-line processing.

From the viewpoints of impact resistance and vacuum formability or drawdown, the high-speed puncture impact energy is preferably 3.0 J or more, more preferably 5.0 J or more, and particularly preferably 9.0 J or more.

The high-speed puncture impact energy can be appropriately adjusted by adjusting the product r1r2 of monomer reactivity ratios of the ethylene-α-olefin copolymer (A), and, for example, the high-speed puncture impact energy can be decreased by decreasing r1r2.

Although there are no particular limitations on a melt flow rate (MFR) of the thermoplastic elastomer composition of the present invention, an MFR measured in accordance with JIS K7210 under conditions of a temperature of 230° C. and a load of 98.07 N is preferably 0.1 g/10 min to 300 g/10 min, more preferably 0.5 g/10 min to 100 g/10 min, and particularly preferably 5 g/10 min to 90 g/10 min.

It is preferable that the melt flow rate (MFR) of the thermoplastic elastomer composition is the lower limit value or more from the viewpoint of ensuring fluidity for molding.

It is preferable that the melt flow rate (MFR) of the thermoplastic elastomer composition is the upper limit value or less from the viewpoints of suppressing burrs during injection molding and ensuring a uniform sheet thickness during extrusion molding.

The melt flow rate (MFR) of the thermoplastic elastomer composition of the present invention can be appropriately adjusted by selecting and adjusting types, physical properties, compounding amounts, and production conditions of respective components constituting the thermoplastic elastomer composition, and, for example, the MFR can be decreased by increasing the amount of the ethylene-α-olefin copolymer (A) used and decreasing the amount of the propylene-based polymer (B) used.

Although there are no particular limitations on a hardness of the thermoplastic elastomer composition of the present invention, a Shore A hardness, measured in accordance with JIS K6253 using a durometer, of a molded article produced from the thermoplastic elastomer composition (for example, an extruded molded article produced by melt-extruding the thermoplastic elastomer composition from a T-die under conditions of using a 25 mm-diameter extruder provided with a T-die having a width of 100 mm, a cylinder temperature of 220° C., a full-flight-type screw, and a screw rotation speed of 40 rpm, bringing an extruded molten film into contact with a metal roll and air-cooling the film along the metal roll to mold the film, stacking six sheets of the extruded molded article (having a width of about 95 mm and a thickness of 1.0 mm) to prepare a sample having a thickness of 6 mm, and measuring the Shore A hardness of the sample) is preferably 40 to 100, more preferably 50 to 95, and particularly preferably 60 to 90.

It is preferable that the Shore A hardness is the lower limit value or more from the viewpoints of mechanical properties and moldability.

It is preferable that the Shore A hardness is the upper limit value or less from the viewpoint of flexibility.

The Shore A hardness can be appropriately adjusted by selecting and adjusting types, physical properties, compounding amounts, and production conditions of respective components constituting the thermoplastic elastomer composition, and, for example, the Shore A hardness can be increased by decreasing the amount of the ethylene-α-olefin copolymer (A) and increasing the amount of the propylene-based polymer (B).

Although there are no particular limitations on a compression set (C.Set) of the thermoplastic elastomer composition of the present invention, a compression set of a molded article produced from the thermoplastic elastomer composition (for example, a molded article having a thickness of about 2.1 mm, produced by preheating the thermoplastic elastomer composition at a temperature of 180° C. and a maximum pressure of 10 MPa for 3 minutes, pressing the thermoplastic elastomer composition for 3 minutes, and performing cooling press molding for 3 minutes) measured in accordance with JIS K6262 at a compression ratio of 25%, a test temperature of 70° C., and a test time of 22 hours is preferably 36% to 70%. The compression set is more preferably 60% or less, still more preferably 58% or less, and particularly preferably 55% or less. The compression set is more preferably 10% or more, still more preferably 20% or more, and particularly preferably 36% or more.

It is preferable that the compression set is the upper limit value or less from the viewpoint of rubber elasticity.

It is preferable that the compression set is the lower limit value or more from the viewpoints of mechanical properties and moldability.

The compression set (C.Set) of the thermoplastic elastomer composition of the present invention can be adjusted not only by the amount of oil but also by selecting and adjusting types, physical properties, compounding amounts, and production conditions of respective components constituting the thermoplastic elastomer composition. For example, the compression set can be decreased by decreasing the amount of the propylene-based polymer (B), increasing the amount of the ethylene-α-olefin copolymer (A), and increasing the amount of the crosslinking agent (D). In addition, when the mineral oil (C) is used, the compression set can also be appropriately adjusted by adjusting the amount of the mineral oil (C).

Although there are no particular limitations on applications of the thermoplastic elastomer composition of the present invention, the thermoplastic elastomer composition is preferably used in various applications in which thermoplastic elastomers have been conventionally suitably used. In particular, the thermoplastic elastomer composition is preferably used to constitute a part or all of various members and products produced by injection molding or extrusion molding.

An injection-molded article, which is a preferred application of the thermoplastic elastomer composition of the present invention, can be produced using the thermoplastic elastomer composition of the present invention by, for example, a conventional injection molding method, or, as necessary, various molding methods such as a gas injection molding method, an injection compression molding method, or a short-shot foam molding method. Although there are no particular limitations on molding conditions in the injection molding, the injection molding can generally be performed at a molding temperature of 100° C. to 300° C., preferably 180° C. to 280° C., an injection pressure of 5 MPa to 100 MPa, preferably 10 MPa to 80 MPa, and a mold temperature of 20° C. to 80° C., preferably 20° C. to 60° C.

The thermoplastic elastomer composition of the present invention is used in various applications, and its applications are not particularly limited. However, the thermoplastic elastomer composition of the present invention can achieve a remarkable technical effect having high practical value in that the high-speed puncture impact energy is low and a resulting molded article has excellent split-open performance, and can also impart various properties derived from the thermoplastic elastomer composition. For these reasons, the thermoplastic elastomer composition is particularly suitably used, for example, as a skin material for interior parts of vehicles, including automobiles, such as an instrument panel and a glove box. In addition, the thermoplastic elastomer composition is suitably used in various automobile interior and exterior parts, as well as various parts of home electric appliances, various parts of housing equipment, various industrial parts, and various building material parts; however, applications of the present invention are not limited thereto.

### EXAMPLES

Hereinafter, the present invention will be described in more detail with reference to Examples; however, the present invention is not limited to these Examples.

Physical properties and characteristics in Examples and Comparative Examples were evaluated by the following methods.

1. Product r1r2 of Monomer Reactivity Ratios

Under the following conditions, the ¹³C-NMR spectrum of the ethylene-α-olefin copolymer was measured, and the product r1r2 of monomer reactivity ratios was determined by the method described in Cheng, Macromolecules, 17, 1950 (1984).
Apparatus: AvanceNEO 600 (10 mm cryoprobe) manufactured by Bruker Corporation
Measurement solvent: 1,2-Dichlorobenzene/1,1,2,2-tetrachloroethane-d2 (85/15 by volume)
Measurement temperature: 135° C.
Measurement method: Powergate proton decoupling method
Pulse width: 45°
Pulse repetition time: 4 seconds
Number of integrations: 256 times
Chemical shift reference: Tetramethylsilane

Hereinafter, as an example, a method for determining the product r1r2 of monomer reactivity ratios for the ethylene-α-olefin copolymer (A-2-i) used in Example 1 is shown. Among carbon atoms in the copolymer, S represents a secondary carbon atom and T represents a tertiary carbon atom. The carbon atoms are classified, for example, as ad, αδd, βδ, δδ, and γδ using Greek letters selected based on the distance from the nearest tertiary carbon atom on each side. α, β, and γ represent positions of the first, second, and third atoms, respectively, from the nearest tertiary carbon atom in the molecular chain. δ represents the positions of the fourth and subsequent atoms from the nearest tertiary carbon atom in the molecular chain. The structure of the following formula shows an example of classification of secondary carbon atoms by these symbols. This structure represents a partial structure of the copolymer with hydrogen atoms omitted.

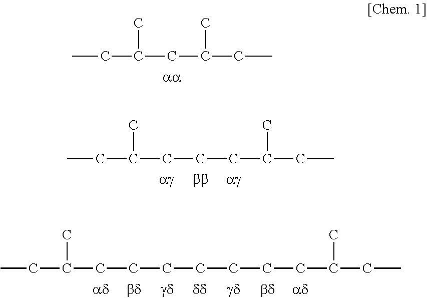

The ¹³C-NMR peaks derived from the respective carbon atoms were identified as shown in FIG. 1. The respective peak areas determined from the spectrum of FIG. 1 were as follows.
Tββ: 0.8082
Tβδ: 2.8015
Tδδ: 7.2456
Sβδ: 14.126
Sδδ: 37.202
Sγδ: 12.993

A peak area PP derived from a portion in which monomer units are bonded in the order of a propylene unit and a propylene unit, a peak area PE derived from a portion in which monomer units are bonded in the order of a propylene unit and an ethylene unit, and a peak area EE derived from a portion in which monomer units are bonded in the order of an ethylene unit and an ethylene unit were determined by the following formulas, and PP, EE, and PE were normalized such that a total of PP, EE, and PE was 100 mol %.

$$PP = T ββ + 1 / 2 T βδ$$

$$EE = 1 / 2 ( S βδ + S δδ ) + 1 / 4 S γδ$$

$$PE = T βδ + 2 T δδ$$

The product r1r2 of monomer reactivity ratios of the ethylene-α-olefin copolymer (that is, a product of an ethylene reactivity ratio r1 and a propylene reactivity ratio r2) was calculated in accordance with the following Formula (3).

$$r 1 r 2 = EE \{ PP / {( PE / 2 )}^{2} \} \qquad Formula ( 3 )$$

2. Melt Flow Rate (MFR, unit: g/10 min)

A melt flow rate (MFR) was measured in accordance with JIS K7210 under conditions of a temperature of 230° C., a load of 98.07 N, and Method B.

### 3. Method of Producing Extruded Molded Article

Using a USV 25-mm-diameter extruder equipped with a 100-mm-wide T-die, manufactured by Union Plastic Corporation, the thermoplastic elastomer compositions of Examples and Comparative Examples were melt-extruded from the T-die under conditions of a cylinder temperature of 220° C., a full-flight type screw, and a screw rotation speed of 40 rpm. The extruded molten film was formed by bringing the film into contact with a metal roll and air-cooling the film, thereby obtaining an extruded molded article (about 95 mm in width and 1.0 mm in thickness).

### 4. Hardness

In accordance with JIS K 6253, six sheets of the extruded molded article obtained by the method described in 3. above were stacked to prepare a sample having a thickness of 6 mm, and an instantaneous value of Shore A hardness was obtained using a durometer.

### 5. Method for Producing Press Sheet

Using a compression molding machine F-37 manufactured by Shinto Metal Industries, Ltd., the thermoplastic elastomer composition of each of Examples or Comparative Examples was subjected to hot press molding at a temperature of 200° C. and a maximum pressure of 10 MPa for 5 minutes, and then to cooling press molding at a temperature of 23° C. and a maximum pressure of 10 MPa for 5 minutes, thereby producing a press sheet (150 mm in length, 150 mm in width, and 2.2 mm in thickness).

### 6. Compression Set

In accordance with JIS K6262, a large test specimen was prepared from the press sheet obtained by the method described in 5. above, and a compression set at a test temperature of 70° C., a compression ratio of 258, and a test time of 22 hours was measured.

### 7. Method for Producing Injection-Molded Article

Using an injection molding machine IS100EN-3A manufactured by Toshiba Machine Co., Ltd., the thermoplastic elastomer compositions produced in Examples and Comparative Examples were injection-molded under conditions of a molding temperature of 220° C. and a mold temperature of 50° C., thereby obtaining injection-molded articles having a length of 150 mm, a width of 90 mm, and a thickness of 2.0 mm.

### 8. High-Speed Puncture Impact Energy

Using Hydroshot HITS-P10 manufactured by Shimadzu Corporation, a high-speed puncture impact test was performed on the injection-molded articles produced in 7. above under conditions of a striker diameter of ½ inch, a striker speed of 2.8 m/s, a specimen support diameter of 40 mm, and a test temperature of 23° C., and high-speed puncture impact energy at a puncture point was measured.

### 9. Evaluation of Ease of Split Opening

Ease of split opening was evaluated from the high-speed puncture impact energy values obtained in 8. above according to the following criteria.
A: The high-speed puncture impact energy is 10.3 J or less, and significantly good ease of split opening is observed.
B: The high-speed puncture impact energy is more than 10.3 J and 10.9 J or less, and good ease of split opening is observed.
C: The high-speed puncture impact energy is more than 10.9 J and 12.0 J or less, and ease of split opening is observed.
D: The high-speed puncture impact energy is more than 12.0 J, and ease of split opening is not recognized.

The details of the materials used in Examples and Comparative Examples are as follows.

### <Component (A)> Ethylene-α-Olefin Copolymer

(A-2-i)+(C): Oil-extended ethylene-propylene-5-ethylidene-2-norbornene copolymer (mixture of 100 parts by mass of component (A1-i) and 50 parts by mass of component (C))
   Mooney viscosity (ML₁₊₄ 125° C.) of (A-2-i)+(C)=53
   Mooney viscosity (ML₁₊₄ 125° C.) of (A1-i) calculated from Formula (1)=113
   Composition of (A-2-i)
Ratio of structural units derived from ethylene=63.2 mass %
Ratio of structural units derived from propylene=32.5 mass %
Ratio of structural units derived from 5-ethylidene-2-norbornene=4.3 mass %

$$EE = 59.7 mol \%$$

$$PP = 4.6 mol \%$$

$$PE = 35.7 mol \%$$

$$r 1 r 2 = 0.8$$

(A-2-ii): Ethylene-propylene-5-ethylidene-2-norbornene copolymer
   Mooney viscosity (ML₁₊₄ 125° C.) of (A-2-ii)=64.
   Composition of (A-2-ii)
Ratio of structural units derived from ethylene=64.7 mass %
Ratio of structural units derived from propylene=31.2 mass %
Ratio of structural units derived from 5-ethylidene-2-norbornene=4.1 mass %

$$EE = 61.7 mol \%$$

$$PP = 3.3 mol \%$$

$$PE = 35. mol \%$$

$$r 1 r 2 = 0.67$$

(A-2-iii)+(C): Oil-extended ethylene-propylene-5-ethylidene-2-norbornene copolymer (mixture of 100 parts by mass of component (A-2-iii) and 100 parts by mass of component (C))
   Mooney viscosity (ML₁₊₄ 125° C.) of (A-2-iii)+ (C)=
   Mooney viscosity (ML₁₊₄ 125° C.) of (A-2-iii) calculated from Formula (1)=169
   Composition of (A-2-iii)
Ratio of structural units derived from ethylene=68.0 mass %
Ratio of structural units derived from propylene=29.0 mass %
Ratio of structural units derived from 5-ethylidene-2-norbornene=3.0 mass %

$$EE = 64. mol \%$$

$$PP = 5. mol \%$$

$$PE = 31. mol \%$$

$$r 1 r 2 = 1.34$$

(A-2-iv)+ (C): Oil-extended ethylene-propylene-5-ethylidene-2-norbornene copolymer (mixture of 100 parts by mass of component (A-2-iv) and 40 parts by mass of component (C))
   Mooney viscosity (ML₁₊₄ 125° C.) of (A-2-iv)+ (C)=54
Mooney viscosity (ML₁₊₄ 100° C.) of (A-2-iv) calculated from Formula (1)=99
   Composition of (A-2-iv)
Ratio of structural units derived from ethylene=64.7 mass %
Ratio of structural units derived from propylene=31.3 mass %
Ratio of structural units derived from 5-ethylidene-2-norbornene=3.9 mass %

$$EE = 61.6 mol \%$$

$$PP = 6.7 mol \%$$

$$PE = 31.7 mol \%$$

$$r 1 r 2 = 1.64$$

(A-2-v)+ (C): Oil-extended ethylene-propylene-5-ethylidene-2-norbornene copolymer (mixture of 100 parts by mass of component (A-2-v) and 75 parts by mass of component (C))
   Mooney viscosity (ML₁₊₄ 125° C.) of (A-2-v)+ (C)=55
Mooney viscosity (ML₁₊₄ 100° C.) of (A-2-v) calculated from Formula (1)=172
   Composition of (A-2-v)
Ratio of structural units derived from ethylene=63.1 mass %
Ratio of structural units derived from propylene=33.5 mass %
Ratio of structural units derived from 5-ethylidene-2-norbornene=3.4 mass %

$$EE = 57.4 mol \%$$

$$PP = 9. mol \%$$

$$PE = 33.6 mol \%$$

$$r 1 r 2 = 1.83$$

### <Component (B)> Propylene Polymer

(B-i): Heterophasic propylene polymer material (manufactured by Sumitomo Chemical Co., Ltd.; trade name “Sumitomo Noblen AH561”)
   MFR (230° C., 21.2 N)=3 g/10 min, [η_{cxis}]=1.7 dL/g, [η_{cxs}]=3.8 dL/g, amount of polymer (I)=80 mass %, structural units derived from ethylene contained in copolymer (II)=37 mass %
(B-ii): Propylene homopolymer (manufactured by Sumitomo Chemical Co., Ltd.; trade name “Sumitomo Noblen D101”)
   MFR (230° C., 21.2 N)=0.5 g/10 min; [η_{cxis}]=3.0 dL/g
(B-iii): Propylene homopolymer (manufactured by Sumitomo Chemical Co., Ltd.; trade name “Sumitomo Noblen Y501N”)
   MFR (230° C., 21.2 N)=13 g/10 min; [η_{cxis}]=1.5 dL/g

### <Component (C)> Mineral Oil

(C-i): Paraffinic mineral oil (manufactured by Idemitsu Kosan Co., Ltd.; trade name “PW-100”)
   Pour point=−12.5° C.

### <Component (D)> Crosslinking Agent

(D-i)+ (C): Trade name “APO-10DL”, manufactured by Kayaku Nouryon Corporation, (mixture of 10 mass % of component (D-i) and 90 mass % of component (C) (provided that the total amount of (D-i) and (C) is 100 wt %))
(D-i): 2,5-Dimethyl-2,5-di(tert-butylperoxy)hexane

### <Component (E)> Inorganic Filler

(E-i): Trade name “MFP-CLLAR”, manufactured by MITSUFUKU INDUSTRY CO., LTD. (masterbatch having calcium carbonate content of 80%)

### <Component (F)> Ethylene-Based Resin

(F-i): Trade name “M6901”, manufactured by KEIYO POLYETHYLENE CO., LTD.
MFR (190° C., 21.18N)=13 g/10 min
Density=962 kg/m³
Ratio of structural units derived from ethylene=More than 90 mass %

Crosslinking coagent: Trade name “Hi-Cross MS-50”, manufactured by Seiko Chemical Co., Ltd. (trimethylolpropane trimethacrylate diluted with silicon dioxide to 50%)

Antioxidant: Trade name “IRGANOX (registered trademark) 1010” manufactured by BASF Japan Ltd.

### Example 1

A thermoplastic elastomer composition was obtained by melt-kneading, at a cylinder temperature of 200° C.±20° C., 45.0 parts by mass of an oil-extended ethylene-propylene-5-ethylidene-2-norbornene copolymer ((A-2-1)+ (C)), 14.0 parts by mass of a heterophasic propylene polymer material (B-i), 15.0 parts by mass of a mineral oil (C-i), 1.8 parts by mass of a crosslinking agent ((D-i)+(C)), 0.4 parts by mass of a crosslinking coagent, and 0.1 parts by mass of an antioxidant, in an upstream section of a twin-screw extruder (TEX34αIII) manufactured by The Japan Steel Works, LTD., and then melt-kneading, at a cylinder temperature of 200° C.±20° C., 6.0 parts by mass of an inorganic filler (E-i) and 20.0 parts by mass of an ethylene-based resin (F-i) in a downstream section of the twin-screw extruder. A molded article was obtained by extrusion molding, press molding, or injection molding the obtained thermoplastic elastomer composition by the methods described in 3, 5, or 7 above. The results of measurement of physical properties of the molded article are shown in Table 1.

### Examples 2 to 6 and Comparative Example 1

A thermoplastic elastomer composition and a molded article were produced and evaluated in the same manner as in Example 1, except that the compounding of the raw materials was changed as shown in Table 1.

The results are shown in Table 1.

TABLE 1

| | | | | | | | | | | | | | | | Com- |
|---|---|---|---|---|---|---|---|---|---|---|---|---|---|---|---|
| | | | | | | | | | | | | | | | par- |
| | | | | C2 | [EE] | [PP] | [PE] | | | | | | | | ative |
| | | | | mass | mol | mol | mol | | Exam- | Exam- | Exam- | Exam- | Exam- | Exam- | Exam- |
| Process | Composition | | | % | % | % | % | r1r2 | ple 1 | ple 2 | ple 3 | ple 4 | ple 5 | ple 6 | ple 1 |
| First | Component | (A-2- | EPDM (50 | 63.2 | 59.7 | 4.6 | 35.7 | 0.86 | 45 | 45 | 65 | | | | |
| process | (A) | i) + | parts oil- | | | | | | | | | | | | |
| | | (C) | extended) | | | | | | | | | | | | |
| | | (A-2-ii) | EPDM | 64.7 | 61.7 | 3.3 | 35.0 | 0.67 | | | | 30 | | | |
| | | | (non-oil- | | | | | | | | | | | | |
| | | | extended) | | | | | | | | | | | | |
| | | (A-2- | EPDM (100 | 68.0 | 64.0 | 5.0 | 31.0 | 1.34 | | | | | 60 | | |
| | | iii) + | parts oil- | | | | | | | | | | | | |
| | | (C) | extended) | | | | | | | | | | | | |
| | | (A-2- | EPDM (40 | 64.7 | 61.6 | 6.7 | 31.7 | 1.64 | | | | | | 45 | |
| | | iv) + | parts oil- | | | | | | | | | | | | |
| | | (C) | extended) | | | | | | | | | | | | |
| | | (A-2- | EPDM (75 | 63.1 | 57.4 | 9.0 | 33.6 | 1.83 | | | | | | | 52.5 |
| | | v) + | parts oil- | | | | | | | | | | | | |
| | | (C) | extended) | | | | | | | | | | | | |
| | Component | (B-i) | Heterophasic propylene polymer material | | | | | | 14 | | 14 | 14 | 14 | 14 | 14 |
| | (B) | (B-ii) | h-PP | | | | | | | 9 | | | | | |
| | | (B-iii) | h-PP | | | | | | | 5 | | | | | |
| | Component | (C-i) | Mineral oil | | | | | | 15 | 15 | 15 | 30 | | 15 | 7.5 |
| | (C) | | | | | | | | | | | | | | |
| | Component | (D-i) + | PO | | | | | | 1.8 | 1.8 | 1.8 | 1.8 | 1.8 | 1.8 | 1.8 |
| | (D) | (C) | | | | | | | | | | | | | |
| | Crosslinking coagent | | | | | | | | 0.4 | 0.4 | 0.4 | 0.4 | 0.4 | 0.4 | 0.4 |
| | Antioxidant | | | | | | | | 0.1 | 0.1 | 0.1 | 0.1 | 0.1 | 0.1 | 0.1 |
| Second | Component | (E-i) | Filler | | | | | | 6 | 6 | | 6 | 6 | 6 | 6 |
| process | (E) | | | | | | | | | | | | | | |
| | Component | (F-i) | HDPE | | | | | | 20 | 20 | | 20 | 20 | 20 | 20 |
| | (F) | | | | | | | | | | | | | | |

| Compounding | Component (A): ethylene-α-olefin copolymer | 100 | 100 | 100 | 100 | 100 | 100 | 100 |
|---|---|---|---|---|---|---|---|---|
| amount (parts | Component (B): propylene-based polymer | 47 | 47 | 32 | 47 | 47 | 44 | 47 |
| by mass) | Component (C): mineral oil | 105 | 105 | 88 | 105 | 105 | 92 | 105 |
| based on 100 | Component (E): inorganic filler | 16 | 16 | 0 | 16 | 16 | 15 | 16 |
| parts by mass | Component (F): ethylene-based resin | 67 | 67 | 0 | 67 | 67 | 62 | 67 |
| of component | | | | | | | | |
| (A) | | | | | | | | |

| | | | | | | | | |
|---|---|---|---|---|---|---|---|---|
| Puncture impact test | J | 10.0 | 10.7 | 10.6 | 9.5 | 11.0 | 11.1 | 12.4 |
| Split-open performance evaluation | — | A | B | B | A | C | C | D |
| MFR (230° C., 10 kg) | g/10 min. | 80 | 89 | 15 | 87 | 46 | 24 | 62 |
| Hardness (Shore A, peak) | — | 86 | 88 | 55 | 74 | 87 | 86 | 85 |
| Compression set | % | 40 | 41 | 45 | 43 | 41 | 42 | 37 |

### INDUSTRIAL APPLICABILITY

The thermoplastic elastomer composition of the present invention has low high-speed puncture impact energy and is capable of forming a molded article having excellent split-open performance, and can also impart various other performances derived from a thermoplastic elastomer composition. Therefore, the thermoplastic elastomer composition is suitably used, for example, as a skin material for various automobile interior parts including instrument panels and glove boxes, and has high applicability in various industrial fields, such as the transportation machinery industry, the electrical and electronic industry, and the building and construction industry.

1. A thermoplastic elastomer composition comprising 100 parts by mass of (A) an ethylene-α-olefin copolymer and 20 parts by mass to 90 parts by mass of (B) a propylene-based polymer,
wherein a ratio of structural units derived from ethylene in all structural units of the ethylene-α-olefin copolymer (A) is 55 mass % or more and less than 80 mass %, and
a product r1r2 of monomer reactivity ratios of the ethylene-α-olefin copolymer (A) is 1.8 or less.

2. The thermoplastic elastomer composition according to claim 1, wherein a molar fraction AA of α-olefin-α-olefin sequences in the ethylene-α-olefin copolymer (A) is 8.5 mol % or less (provided that a total of peak areas AA, AE, and EE is defined as 100 mol %, where the peak area AA is derived from a portion in which monomer units are bonded in the order of an α-olefin unit and an α-olefin unit, the peak area AE is derived from a portion in which monomer units are bonded in the order of an α-olefin unit and an ethylene unit, and the peak area EE is derived from a portion in which monomer units are bonded in the order of an ethylene unit and an ethylene unit).

3. The thermoplastic elastomer composition according to claim 1, wherein the ethylene-α-olefin copolymer (A) has a structural unit derived from a non-conjugated diene.

4. The thermoplastic elastomer composition according to claim 1, further comprising (C) mineral oil.

5. The thermoplastic elastomer composition according to claim 1, further comprising (D) a crosslinking agent.

6. The thermoplastic elastomer composition according to claim 1, further comprising (E) an inorganic filler.

7. The thermoplastic elastomer composition according to claim 1, further comprising (F) an ethylene-based resin in which a ratio of structural units derived from ethylene is 80 mass % or more.

8. The thermoplastic elastomer composition according to claim 7, wherein a density of the ethylene-based resin (F) is 950 kg/m³ or more.

9. A method for producing the thermoplastic elastomer composition according to claim 1, the method comprising melt-kneading (A) an ethylene-α-olefin copolymer and (B) a propylene-based polymer in the presence of (D) a crosslinking agent.

10. The method for producing the thermoplastic elastomer composition according to claim 9, the method further comprising adding (F) an ethylene-based resin to a melt-kneaded product obtained by melt-kneading the ethylene-α-olefin copolymer (A) and the propylene-based polymer (B) in the presence of the crosslinking agent (D), and further melt-kneading the resulting mixture.

11. A molded article comprising
the thermoplastic elastomer composition according to claim 1, wherein
a compression set is 36% to 70% as measured in accordance with JIS K6262 at a compression ratio of 25%, a test temperature of 70° C., and a test time of 22 hours.

12. A vehicle interior skin comprising the thermoplastic elastomer composition according to claim 1.
